(19) United States
(12) Patent Application Publication
(10) Pub. No.: US 2016/0366110 A1
(43) Pub. Date: Dec. 15, 2016

(54) SECURED CELL PHONE COMMUNICATION SYSTEM

(71) Applicant: Manouchehr Shahbaz, Houston, TX (US)

(72) Inventor: Manouchehr Shahbaz, Houston, TX (US)

(21) Appl. No.: 15/247,906

(22) Filed: Aug. 25, 2016

Related U.S. Application Data
(63) Continuation of application No. 14/713,136, filed on May 15, 2015, now abandoned.

(51) Int. Cl. H04L 29/06; H04W 4/06; H04W 12/02; H04W 4/12

(52) U.S. Cl. CPC H04L 63/0428; H04W 4/12; H04W 4/06; H04W 12/02; H04L 63/168

(57) ABSTRACT

The present invention is regarding a cellphone communication security system comprising a first cellphone; a second cellphone; a network system; a software application installed on at least one of the first and second cellphones, wherein the portal software is configured to receive a user input in form a message on the first cellphone for sending to the second cellphone, wherein the portal software encrypts the user input before transmitting to the second cellphone over the network system; the second cellphone receives the encrypted text to the second cellphone; the second cellphone displays the encrypted message; and wherein the message is decrypted by providing the software application of the second cellphone a key input.

### FIELD OF THE INVENTION

This invention relates to secured cellphone communication and, more specifically, to a system and method to allow for secure transmission of messages or voice over a cellular network or Internet wherein the message may only be decoded by a users) having a designated key.

### BACKGROUND OF THE INVENTION

This application is a continuation of the U.S. patent application Ser. No. 14/713,136, titled “Secured Cellphone Communication System” field on May 15, 2015.

Multimedia messaging is a term used to describe the exchange of messages between cellphones over a cellular network or cloud network. While the term most often refers to messages sent using the text message or SMS, it has been extended to include messages containing image, video, tweet, and sound content, such as Multimedia Message Service messages. Individual messages are referred to as “text messages” or “texts”.

Texting is a popular means of communication worldwide. In particular, smartphones have increased the ease and popularity of texting. In the United States alone, a smartphone owner of age 18-24 sends an average of 2,022 text per month.

In general, cellphones send signals to a cell phone tower over a pathway called a control channel so that the cell phone system knows which cell area the cellphone is located in, and so that the cellphone can change cell areas as a person moves around. The cellphone uses the control channel for call setup. The control channel also provides a pathway for text messages. When a user sends a message, the text message may take one the following three trajectories. message can be, send from Mobile to another Mobile, this trajectory is referred as MO-MT (Mobile Originated-Mobile Terminated), message can be send from Mobile to a content provider (also called as Large Account/ESME), this trajectory is referred as MO-AT (Mobile Originated-Application Terminated); and message can be sent from Application to a Mobile, this trajectory is referred as AO-MT (Application Originated-Mobile Terminated). In all of the aforementioned trajectories, the cellphone of the user sends the text message to a cell tower on the control channel as data packets. The data packets go from the cell tower to a Short Message Service Center (SMSC) and from there to a receiving cellphone via another cell tower.

Presently, text messages are unsecure. Thus, the text message data packets may be intercepted and read as the data packets travel over the control channel. Further, most Short Message Service Center will store all text messages. These text messages are stored at the SMSC for a predetermined length of time. Since the text messages are unsecured, the text messages may be viewed and read at the SMSC. The same is also true for the voice data. The voice packet data in the cellular network is also stored on the network and can be intercepted.

Therefore, a need existed to provide a system to overcome the above problem. The system would provide for secured transmission of message and/or voice data.

### BRIEF DESCRIPTION OF THE DRAWINGS

FIG. 1 is a simplified functional block diagram of a system of the present invention;

FIG. 2 is a simplified functional block diagram of a cellphone having encryption/decryption software; and

FIG. 3 is a simplified functional block diagram of a method of transmitting secured messages.

### DETAILED DESCRIPTION

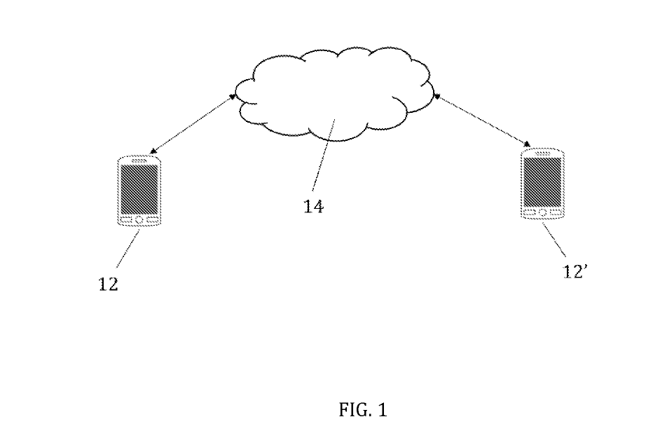

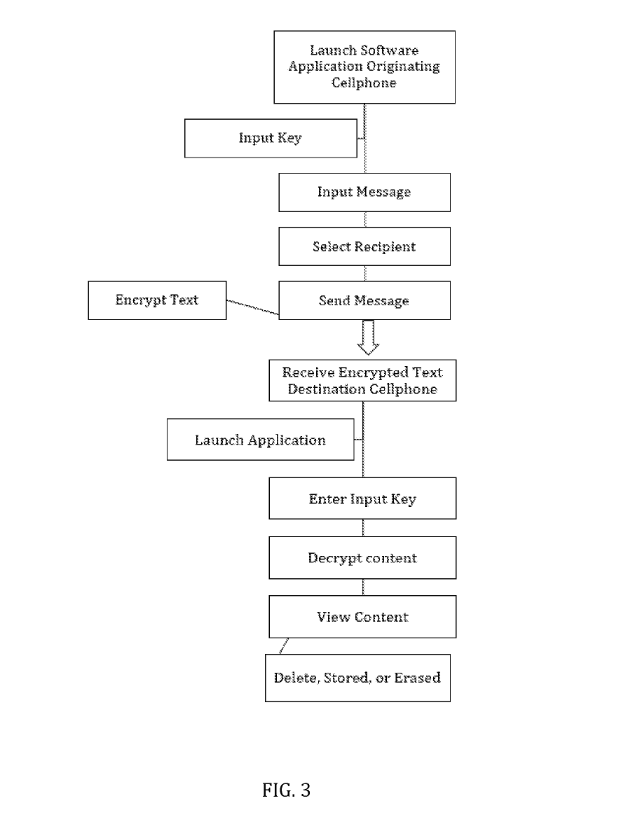

Referring to FIGS. 1-3 a cellular network 10 shown. The cellular network 10 may have a plurality of cellphones 12. While FIG. 1 shows two cellphones 12, this is only shown as an example, a plurality of cellphones may be placed in the network 10 without departing from the spirit and scope of the present invention. The cellular network 10 may have a plurality of cellular towers (not shown). The cellphones 12 send signals to one or more cell phone towers. The signals are sent over a pathway called a control channel so that the cellular system 10 for determination for location determination and then for rerouting to the cellular network 14.

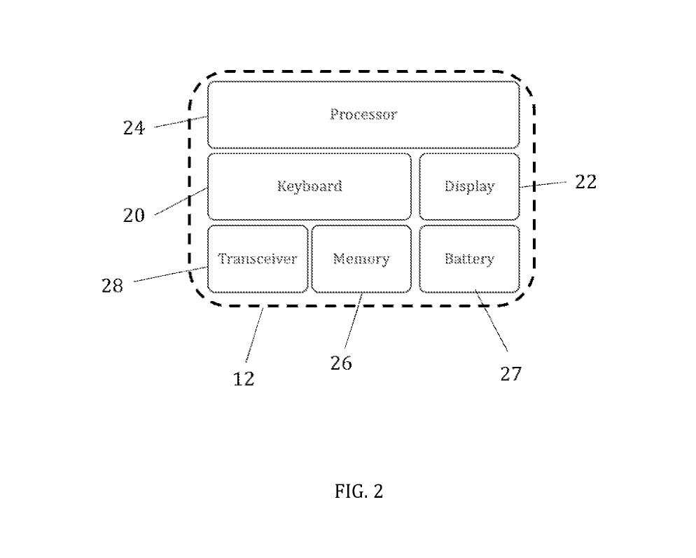

In FIG. 2, a block diagram of an embodiment of a cellphone 12 is shown. The cellphone 12 may be a smartphone comprising display 22, a processor 24, a memory system 26, and a transceiver 28.

The processor 24 may be a microcomputer or the like. The processor 24 serves to control the display 22 and software components installed on the memory 26 of the cellphone 12. The processor 24 serves to control a telecommunicating state according to various control signals received through the transceiver 28.

Referring now to FIG. 1-3, a user who wishes to send and receive secure text message to engage in secured conversation may have an option to install a software application 30 (commonly known as an “app”) on the cellphone 12. The software application 30 may be a software (e.g., embedded, downloadable, subscribed) or a combination software and hardware. For example, the software may be loaded on the cellphone 12 at the time of purchase of the cellphone 12, or at a later time in the form of an application form an application store (e.g., iTunes, Google Play, etc.) The software application 30 may include a hardware component such as an encryption card that may be coupled to a memory slot, input output ports, or the like. Again, if a portion of the software application 30 is a hardware component, the hardware component may be on the cellphone 12 at the time of purchase of the cellphone 12, or added on at a later time.

In accordance with one embodiment, the software application 30 is a software program. The user may have to review and agree to a licensing agreement or may have to agree to some type of payment in order to download the software. The payment may be a one-time fee, a monthly fee, or the like.

Referring now to FIGS. 1-3, a user of a cellphone 12 who wants to send a secure text message generally should have a text message enabled cellphone 12 such as a smartphone. The cellphone 12 further should allow software application 30 to be installed on the memory 26 of the cellphones 12. The memory may be a hard drive, flash drive, a card, storage unit, a short term memory (RAM) or a combination thereof.

The user then will have to launch the software application 30. The user then must write into the software application the content of text message that the user wishes to send via keyboard 20, which could be an actual or virtual keyboard. The user then has to select a recipient from an address book of the cellphone 12. As stated above, the text message could be a written text, an image, video, or voice mail. The entered text may be displayed on the display 22 into the software application 30. When the user presses a transmit button or a send icon (not shown) to send the text message 34, the text data will first be encrypted by the software application 30. The software 30 may include an encryption algorithm to encrypt the text message, using one of Symmetric-key cryptography encryption method, a Public Key encryption method, or the like which will be used to encrypt the text message content and headers (e.g., name and information of the sender). The above listing is exemplary and other variations and modifications to the encryption methodologies above should be within the scope of the present invention.

The encrypted text message is then transmitted by the cellphone 12 of the sender to a cell tower on the control channel as encrypted data packets. The encrypted data packets go from the cell tower to a Short Message Service Center generally the cell carrier in the network 14. The encrypted data packets are then sent to the second cellphone 12′ of a designated receiving party. The designated receiving party being the person designated by the sending party and selected from the address book of the cellphone 12.

In order for the designated receiving party to decode the encrypted data packets to read the text message, the cellphone 12′ should also be a text message enabled cellphone 12′. The text message will display on the designated cellphone 12′ as a combination of alphabets and digits that are not comprehensible as displayed on display 22 of the designated cellphone 12′.

The designated cellphone 12′ further should have the software application 30 installed. As stated above, the software application 30 may be a software upload, a hardware component, or a combination thereof. The software application 30 should have a key for decrypting the encrypted data packets received for the text message to be viewed. However, the user of the designated cellphone 12′ must be aware of a key input (e.g., a password) before he/she can open the portal and access the software application to view the content of text message.

In a symmetric key cryptography encryption method, a single key input is shared by the sender and receiver of the text message for both encryption and decryption. To use a symmetric encryption scheme, the sender and receiver must securely share a key in advance using several means including by not limited conversation, email, fax, text, etc. In this type of encryption method, when loading the software application 30, the owner of the cellphone 12 would generally have to designate a list of recipients. The cellphone 12′ of the owner and each of the designated recipients would then have to be loaded with the software application 30 having the shared key input.

In a public-key cryptography encryption method, asymmetric key algorithms are used, where the key input used to encrypt the text message on the cellphone 12 of the sender is not the same as the key used to decrypt the encoded text message on the cellphone 12′ of the recipient. Each user has a pair of cryptographic keys—a public key and a private key. The private key is kept secret, whilst the public key may be widely distributed. The private is not a permanent key and the use can change the key will. Messages are encrypted with the recipient's key input and can only be decrypted with the corresponding personal key input. The keys may be related mathematically, but the personal key input cannot be derived from the sender's key input.

Once the recipient on the cellphone 12′ has received the encrypted text message from the sender and decrypted the text message in the software application 32, the decrypted text message will be shown on the display 22 of the cellphone 12′ of the recipient when the recipient launches the software application 30 using his or her key input. The recipient may then close the text message or send a reply using the application software 30. If the recipient closes the text message, the recipient may have an option to either save or delete the text message. In some embodiments, the sender or recipient has the option to have the message deleted after a certain span of time. For instance, the text message will be permanently deleted after a certain time selected by the sender of the text or receiver of the text.

As states above, to respond to a text securely, the recipient has to respond to the text message from the cellphone 12′ via the keyboard 36 into the software application 30. The entered response is visible while the user is in the software application's 30 environment. When the recipient presses a transmit button (not shown) to send the response, the response will first be encrypted by the software application 30. The encryption method may be a Symmetric-key cryptography encryption method, a public-key cryptography encryption method or the like.

The encrypted response is then transmitted by the cellphone 12′ of the recipient over the network 14 as encrypted data packets. The encrypted data packets are then sent to the cellphone 12 of the original sender of the first text message and will display on the screen 22 as an encrypted text. The user of the first cellphone 12 then is able to see the content of the text message by launching the software application 30 and inputting his or her key input which would activate the software application 30 to decrypt the text message and make the content of the text message visible.

In some embodiments of the present invention, the user of originating cellphone 12 may send an encrypted text message using the software application 30 to a plurality of cellphones 12′ in the network 10 simultaneously. The receiving cellphones then need to have their own key input to activate the software application on their cellphones to view the content of the text message.

In some embodiments of the present invention the software application 30 may be an invisible software without an icon representing the software application showing on the display of the cellphone such that only the user with knowledge can access or locate said icon.

Furthermore, in some embodiment, the software application 12, may be used to encrypt the voice of the user. The application will allow the user to make a secure call to the recipient cellphone, who will have to respond to the call by activating the software application 30. The software application 30 will parse the calling user's voice into encrypted data packets in real-time and sends to the recipient phone, which will decrypt the packets and convert those packet to understandable voice in real-time. The advantage of sending encrypted packets over the network is that the content of voice or text message may not be understood by a third party during the transmission from originating cellphone to the receiving cellphone over the network and vice versa.

In some embodiments, the software application 30 may also be available in form of a secured webpage, wherein the receiver of an encrypted text message will have to login to the webpage by providing specific login and password and enter his or her designated key to view the content of the encrypted text message.

This disclosure provides exemplary embodiments of the present invention. The scope of the present invention is not limited by these exemplary embodiments. Numerous variations, whether explicitly provided for, by the specification or implied by the specification, such as variations in structure, dimension, type of material and manufacturing process may be implemented by one of skill in the art in view of this disclosure.

1- A cell phone communication security system comprising:
a first cell phone;
a second cell phone;
a network system;
a software installed on at least one of the first and second cell phone, wherein the software is configured to receive a user input in form of a message on the first cell phone for sending to the second cell phone, wherein the software encrypts both, the message and a header of the message before transmitting to the second cell phone over the network system;
the second cell phone receive an encrypted message to the second cell phone;
the second cell phone displays the encrypted message; and
wherein the encrypted message is decrypted by providing the software application of the second cell phone a key input.

2- The cellphone communication security system of claim 1 further comprising a web page stored on a server and accessible by a computer, the web page comprising a user interface allowing a user to view message by providing the key input.

3- The cellphone communication security system of claim 1 wherein the message is selected from a group comprising of a short message service (SMS) message, video, text, voice, image, or a combination thereof.

4- The cellphone communication security system of claim 1 wherein the software application comprises a parser for decrypting the message.

5- The cellphone communication security system of claim 1 wherein the software application is an embedded software application, which is embedded in the operating system of at least one of first or second cellphones.

6- The cellphone communication security system of claim 1, wherein the software application is an invisible application.

7- The cellphone communication security system of claim 1, further comprising a plurality of cellphones wherein the first cellphone sends message to a plurality of cellphones.

8- The cellphone communication security system of claim 1 further comprising one of saving the message after decrypting, the encrypted text message, deleting the text message after decrypting the encrypted text message, or responding to the text message after decrypting the encrypted text message.

9- The cellphone communication security system of claim 1, further comprising entering a response message in the software application of the second cellphone, encrypting the response message on the second cellphone; and transmitting the encrypted response message to the first cellphone.

10- The cellphone communication security system of claim 1 wherein the software application is a downloadable software application comprising an end user licensing agreement prior to downloading the software application and entering payment for downloading the software application.

11- The cell phone communication security system of claim 1, wherein the header includes name and other information of the sender.
